(19) United States
(12) Patent Application Publication
(10) Pub. No.: US 2022/0281745 A1
(43) Pub. Date: Sep. 8, 2022

(54) ALUMINUM NITRIDE PARTICLE

(71) Applicant: NGK Insulators, Ltd., Nagoya-Shi (JP)

(72) Inventors: Hiroharu KOBAYASHI, Kasugai-Shi (JP); Tatsuya HISHIKI, Nagoya-Shi (JP); Katsuyuki TAKEUCHI, Aisai-Shi (JP); Yoshimasa KOBAYASHI, Nagoya-Shi (JP)

(73) Assignee: NGK Insulators, Ltd., Nagoya-Shi (JP)

(21) Appl. No.: 17/804,319

(22) Filed: May 27, 2022

Related U.S. Application Data
(63) Continuation of application No. PCT/JP2020/042864, filed on Nov. 17, 2020.

(30) Foreign Application Priority Data
Dec. 23, 2019 (JP) 2019-231840

(51) Int. Cl. C01B 21/072

(52) U.S. Cl. CPC C01B 21/072; C01P 2004/61; C01P 2006/80

(57) ABSTRACT

An aluminum nitride particle used as a material for an aluminum nitride plate may comprise a carbon content of 100 ppm or less as measured using a pressurized sulfuric acid decomposition method.

### TECHNICAL FIELD

This application claims priority to Japanese Patent Application No. 2019-231840 filed on Dec. 23, 2019, the entire contents of which are incorporated herein by reference. The disclosure herein discloses art related to an aluminum nitride particle. Especially, the disclosure herein discloses art related to an aluminum nitride particle used as a material for an aluminum nitride plate.

### BACKGROUND ART

Japanese Patent Application Publication No. 2012-140325 (hereafter referred to as Patent Literature 1) describes a method of manufacturing a group Ill nitride semiconductor, more specifically an aluminum nitride plate (single crystalline plate). The aluminum nitride plate is used as a base substrate for growing a group III nitride semiconductor such as gallium nitride due to their similarity in lattice constant. In Patent Literature 1, in the manufacturing method using a sublimation method, a material is sublimated by heating a material space where the material is placed to a high temperature while a base substrate space in which a base substrate is placed is maintained at a low temperature. In Patent Literature 1, re-sublimation of aluminum nitride grown on the base substrate is suppressed by maintaining the base substrate space at a lower temperature than in the material space, and thereby growth speed of the aluminum nitride plate is improved.

### SUMMARY OF INVENTION

An aluminum nitride plate may be required to have high optical transparency (such as full-transmittance rate). For example, in a manufacturing process of a semiconductor device, if light needs to be emitted from a rear surface of an aluminum nitride plate to a functional layer (semiconductor layer) formed on a front surface of the aluminum nitride plate, high optical transparency would be required. As another example, high optical transparency is required when the aluminum nitride plate is used as a light emitting unit in a light emitter. In the manufacturing method of Patent Literature 1, the growth speed of the aluminum nitride plate can be improved. However, in the manufacturing method of Patent Literature 1, impurities such as carbon may contaminate the aluminum nitride plate. The impurities such as carbon can be removed when the aluminum nitride plate is heated (sintered) in the manufacturing process of the semiconductor device (in a heat treatment step). However, when such impurities such as carbon are removed from the aluminum nitride plate, voids are left remaining in the aluminum nitride plate. Voids scatter light, thus become factors that decrease the light transmittance rate (full-transmittance rate). The disclosure herein discloses art that realizes an aluminum nitride plate with an improved full-transmittance rate.

The inventors studied materials (aluminum nitride particles) used for manufacturing an aluminum nitride plate, and have discovered that void generation can be suppressed by using a specific material. The disclosure herein is based on this discovery, and discloses a novel aluminum nitride particle used as a material for an aluminum nitride plate. The aluminum nitride particle disclosed herein may have a carbon content of 100 ppm or less. By using such an aluminum nitride particle, a carbon content in the aluminum nitride plate (or in an intermediate body obtained in the course of manufacturing the aluminum nitride plate) decreases, and void generation in the aluminum nitride plate that occurs by elimination of carbon in a heat treatment such as sintering can be suppressed. Carbon itself is another factor that decreases optical transparency. Due to this, reducing the carbon content in the aluminum nitride plate is a useful technique in improving the optical transparency of the aluminum nitride plate even when heat treatment is performed at a relatively low temperature (temperature at which carbon tends not to be eliminated) in a manufacturing process of the aluminum nitride plate or in the manufacturing process of the semiconductor device using the aluminum nitride plate as its substrate.

### BRIEF DESCRIPTION OF DRAWINGS

FIG. 1 shows results in an embodiment.

### DETAILED DESCRIPTION

An aluminum nitride particle disclosed herein may be used as a useful material for an aluminum nitride plate (single crystalline aluminum nitride plate or polycrystalline aluminum nitride plate). Specifically, the aluminum nitride particle may be used as a material for an aluminum nitride plate that is required to have excellent optical transparency. The aluminum nitride plate may be fabricated by a sublimation method, or by producing a flat plate-shaped compact (intermediate body) using aluminum nitride powder, and thereafter subjecting the compact to sintering using an atmospheric sintering method, hot-press method, hot isostatic pressing (HIP) method, or spark plasma sintering (SPS) method. A temperature required in these sintering methods (sintering temperature) for fabricating the aluminum nitride plate can be lower as compared to the sublimation method, thus manufacturing cost of the aluminum nitride plate can thereby be reduced. The aluminum nitride particle disclosed herein can suitably be used as the material for producing the aluminum nitride plate using the sintering methods.

The aluminum nitride particle may be in a granular shape with a size (median diameter, for example) of 0.1 μm or more and 10 μm or less. The size of the aluminum nitride particle can be measured by a particle size distribution analyzer. By configuring the size of the aluminum nitride particle to 0.1 μm or more, the aluminum nitride particle itself can have sufficient weight, which improves handling performance of the aluminum nitride particle in manufacturing the aluminum nitride plate. That is, in manufacturing the aluminum nitride plate, the aluminum nitride particle can be suppressed from scattering (dispersed) in air. Further, when the aluminum nitride plate is to be manufactured by performing sintering (sintering) after fabrication of the aforementioned compact (intermediate body), a density of the compact can sufficiently be increased. By increasing density of the compact, strength of the compact (strength to maintain its form as a compact) can be suppressed from decreasing. The size of the aluminum nitride particle may be 0.5 μm or more, may be 1 μm or more, may be 2 μm or more, may be 3 μm or more, may be 4 μm or more, may be 6 gm or more, or may be 8 μm or more.

By setting the size of the aluminum nitride particle to 10 μm or less, the aluminum nitride particle can be sublimated (vaporized) in a relatively short time in manufacturing the aluminum nitride plate using the aforementioned sublimation method. Further, in manufacturing the aluminum nitride plate by sintering the compact (intermediate body), generation of large voids (gap between aluminum nitride particles) in the compact can be suppressed. As a result, voids can be suppressed from remaining in the aluminum nitride plate after sintering of the compact. The size of the aluminum nitride particle may be 8 μm or less, may be 6 μm or less, may be 5 μm or less, may be 4 μm or less, or may be 2 μm or less.

The aluminum nitride particle may have a distorted outer shape. That is, the aluminum nitride particle may not be spherical (with sphericity of 0.8 or less, for example), but may have a crushed shape with a surface of a sphere in a crushed form. Typically, as the sphericity of the aluminum nitride particle decreases (as its outer shape becomes distorted), a specific surface area of the aluminum nitride particle increases. Due to this, for example, in the case where the aluminum nitride plate is to be manufactured by the sublimation method, a heat-receiving surface area of the aluminum nitride particle increases as the sphericity of the aluminum nitride particle decreases, and the aluminum nitride particle can be sublimated (vaporized) in a relatively short time. Further, in the case where the aluminum nitride plate is to be manufactured by sintering the compact (intermediate body), a contact area between the aluminum nitride particles therein increases as the sphericity of the aluminum nitride particles decreases, and a time required for the sintering can be shortened. As a method of decreasing the sphericity of the aluminum nitride particles, a method of pulverizing the aluminum nitride particles by using such as a dry jet mill may be raised.

Further, the aluminum nitride particle may be in a non-agglomerated form, that is, in a form of a primary particle. When the aluminum nitride particle is in the form of the primary particle, the heat-receiving surface area of the aluminum nitride particle can be increased, and further the contact area between the aluminum nitride particles can be increased. The aluminum nitride particles may be pulverized by using for example the aforementioned dry jet mill, by which an agglomerate of aluminum nitride particles (secondary particles) can be separated into the form of primary particles.

However, in manufacturing the aluminum nitride plate by sintering the compact, when the sphericities of the aluminum nitride particles are too low, a distance between the aluminum nitride particles (distance between their centers) may become too far and thereby the sintering between the aluminum nitride particles may not progress as required. Further, when the sphericities of the aluminum nitride particles are too high, the contact area between the aluminum nitride particles decreases, by which a gap is easily generated between the aluminum nitride particles. Due to this, when the aluminum nitride plate is manufactured by sintering the compact, it is preferable that the aluminum nitride particles are in suitably distorted shapes. Specifically, when the aluminum nitride particle is viewed in a plan view, a perimeter of the particle with respect to the size of the particle in the plan view may be 3.5 times or more and 7 times or less the size.

The “size” in the plan view may refer to a “size” of the aluminum nitride particle that is observed in an observation screen when the aluminum nitride particle is observed by for example a SEM, and may more specifically mean a diameter of the particle when the particle appearing in the screen is assumed as being circular. That is, it may refer to a value obtained by dividing an area of the aluminum nitride particle appearing in the observation screen by 7C. Due to this, the “size” in the plan view when the aluminum nitride particle is viewed in the plan view may be different from the “size” measured by the particle size distribution analyzer (actual particle diameter). Further, when the aluminum nitride particle is to be observed by the SEM, the surface (outer surface) of the aluminum nitride particle may be observed, or a cross section of the aluminum nitride particle may be observed.

When the perimeter of the particle with respect to the size of the particle in the plan view (hereinbelow termed “perimeter ratio”) is 3.5 times or more the size of the particle, the contact area between the aluminum nitride particles can sufficiently be secured, and voids can be suppressed from remaining in the sintered aluminum nitride plate. Further, when the perimeter ratio is 7 times or less, an inter-particle distance (distance between the centers of the aluminum nitride particles) can be suppressed from becoming too large, thus a large gap can be suppressed from being generated between the aluminum nitride particles. The perimeter ratio may be 3.6 times or more, may be 3.8 times or more, may be 4 times or more, or may be 5 times or more. Further, the perimeter ratio may be 4.5 times or less, may be 4.2 times or less, may be 4 times or less, may be 3.8 times or less, or may be 3.6 times or less.

The aluminum nitride particle may be a single crystalline or polycrystalline particle, and is preferably a single crystalline particle from the viewpoint of improving optical transmittance of the aluminum nitride plate. Further, the aluminum nitride particle preferably has a carbon content of 100 ppm or less in order to reduce carbon contained in the aluminum nitride plate (including the intermediate compact). This can suppress the generation of the voids in the aluminum nitride plate caused by elimination of the carbon in the course of manufacture. Further, the carbon content in the aluminum nitride plate can be reduced even when a step to eliminate the carbon (high-temperature heat treatment step) is not performed in the course of manufacture.

When the carbon or voids exist in large quantity within the aluminum nitride plate, the optical transparency of the aluminum nitride plate is deteriorated. Specifically, the carbon or voids cause scattering of light that travels (is transmitted) through the aluminum nitride plate. By using the aluminum nitride particle with the carbon content of 100 ppm or less, the carbon content in the aluminum nitride plate or an amount of the voids in the aluminum nitride plate can be reduced. The carbon content in the particle may be 90 ppm or less, may be 70 ppm or less, may be 50 ppm or less, may be 20 ppm or less, may be 15 ppm or less, or may be 10 ppm or less. The carbon content in the aluminum nitride particle may be measured using an Inductively Coupled Plasma (ICP) optical emission spectrometer, or a X-ray photoelectron spectroscopic device.

When the aluminum nitride particle is to be used as the material for manufacturing the aluminum nitride plate by sintering the compact (intermediate body), the aluminum nitride particle may contain a suitable amount of oxygen. Specifically, the aluminum nitride particle may have an oxygen content in the particle (oxygen concentration over an entirety of the particle) of 500 ppm or more and 8000 ppm or less. By setting the oxygen content in the particle to 500 ppm or more, a liquid phase tends to occur in preliminary sintering (primary sintering that is performed prior to secondary sintering), which reduces the gap between the particles, and an aluminum nitride plate with a high density can thereby be produced. That is, the voids in the aluminum nitride plate can be reduced. The oxygen content in the particle may be 1000 ppm or more, may be 3000 ppm or more, may be 5000 ppm or more, may be 7000 ppm or more, or may be 7800 ppm or more. Further, the oxygen content in the particle may be 7800 ppm or less, may be 7000 ppm or less, may be 5000 ppm or less, may be 4000 ppm or less, may be 3000 ppm or less, or may be 1000 ppm or less. The oxygen content in the particle can be measured by using an oxygen analyzer.

The oxygen content in the aluminum nitride particle may be different between a surface layer and a particle interior (portion covered by the surface layer). Specifically, the oxygen content in the particle surface layer may be higher than the oxygen content in the particle interior. In other words, the aluminum nitride particle may comprise a first region in which the oxygen content is high provided on the particle surface layer, and a second region in which the oxygen content is lower than that of the first region provided inward of the first region (on the particle center side). The first region may cover the second region. Further, the first region may be aluminum oxide (Al₂O₃) obtained by oxidization of aluminum nitride. The second region may be a solid solution in which oxygen is homogenously mixed with aluminum nitride (AIN-O₂ solid solution). The “oxygen content in the particle” described as above corresponds to a total oxygen content of the first and second regions (total oxygen content of the entire particle).

The oxygen content of the second region (particle interior) may be 500 ppm or less. When the aluminum nitride plate is manufactured using the aluminum nitride particle with the oxygen content of the second region being 500 ppm or less, full-transmittance rate of the aluminum nitride plate can further be increased. The oxygen content of the second region may be 400 ppm or less, may be 300 ppm or less, may be 200 ppm or less, or may be 100 ppm or less.

As aforementioned, the oxygen content in the particle can be measured by using the oxygen analyzer. By performing measurement using the oxygen analyzer with an “inert gas fusion and infrared absorption method”, the oxygen content of the particle surface layer can be detected at a low temperature (lower than 1900° C.) and the oxygen content of the particle interior can be detected at a high temperature (1900° C. or higher). As another index indicative of an oxygen content distribution in the particle (oxygen concentration distribution), the oxygen content measured between a particle surface and a depth of 5 nm therefrom toward the center may be regarded as the oxygen content of the particle surface layer (first region), and the oxygen content measured deeper than the depth of 5 nm (on the center side) may be regarded as the oxygen content of the particle interior.

The aluminum nitride particle disclosed herein may be obtained by heat-treating a conventional aluminum nitride particle under presence of aluminum oxide. Specifically, the aluminum nitride particle and aluminum oxide may be sintered under a nitrogen atmosphere at 1700 to 2300° C. for 10 to 15 hours. Due to this, carbon contained in the aluminum nitride particle (conventional aluminum nitride particle) and oxygen constituting the aluminum oxide react with each other, by which the carbon contained in the aluminum nitride particle is eliminated, and the aluminum nitride particle with low carbon content (100 ppm or less) as disclosed herein can thereby be obtained. Typically, an oxide film (aluminum oxide) is formed on the surface of the aluminum nitride particle. Due to this, the aluminum oxide that is subjected to heat treatment together with the aluminum nitride particle may be the oxide film (aluminum oxide) formed on the surface of the aluminum nitride particle. If the carbon content in the aluminum nitride particle (conventional aluminum nitride particle) is relatively low (200 ppm to 1000 ppm), the carbon contained in the aluminum nitride particle can be eliminated by sintering the aluminum nitride particle under the nitrogen atmosphere at 1700 to 2000° C.

If the carbon content in the aluminum nitride particle (conventional aluminum nitride particle) is relatively high (exceeding 1000 ppm), a mixture obtained by adding an aluminum oxide particle to the aluminum nitride particle may be sintered under the aforementioned conditions.

When the aluminum oxide particle is to be added to the aluminum nitride particle, an amount of the aluminum oxide particle to be added is suitably adjusted in accordance with the carbon content in the aluminum nitride particle so that the aluminum oxide particle does not remain after the sintering (after carbon elimination). The aforementioned sintering temperature and time are suitably adjusted in accordance with a pre-sintering state of the aluminum nitride particle (such as its carbon content, size, and shape) and a state of the aluminum nitride particle aimed to be obtained. As an example of the aluminum nitride particle aimed to be obtained, the state of the aluminum nitride particle is adjusted so that an aluminum nitride plate with 68% optical transparency (full-transmittance rate) is obtained in fabricating the aluminum nitride plate using the aluminum nitride particle.

The conventional aluminum nitride particle is fabricated by reducing the aluminum oxide particle under the nitrogen atmosphere. Carbon is used as a reducing agent in the reduction. That is, the conventional aluminum nitride particle is fabricated using a reaction “Al₂O₃+3C+N₂→2AIN+3CO”. Due to this, carbon that was used as the reducing agent may remain in the aluminum nitride particle. The aluminum nitride particle disclosed herein can be evaluated as having eliminated such residual carbon used in the manufacturing process of the aluminum nitride particle by further sintering the aluminum nitride particle obtained by a conventional manufacturing method together with aluminum oxide.

An example of a manufacturing method of the aluminum nitride plate that uses the aluminum nitride particle disclosed herein as its material will be described. Here, a method of manufacturing the aluminum nitride plate by fabricating a flat plate-shaped compact using a material containing the aluminum nitride particle, fabricating a primary sintered body (intermediate body) by sintering this compact, and further subjecting the primary sintered body to secondary sintering (main sintering) will be described.

Firstly, a pre-sintering compact with a predetermined size is fabricated using the aluminum nitride particles. The pre-sintering compact may for example be formed by applying and drying a slurry containing the aluminum nitride particles on a film, stacking compacts separated from the film to achieve a predetermined thickness, and isostatically pressing this stack. After this, a forming-auxiliary agent that was added in forming the pre-sintering compact is degreased, and the pre-sintering compact is sintered at a predetermined temperature under pressure application to sinter and grow the particles of the aluminum nitride, as a result of which a high-density aluminum nitride primary sintered body is formed. In the course of forming the primary sintered body, gaps between the aluminum nitride particle are eliminated. Then, the aluminum nitride primary sintered body is polished to adjust its thickness, and the aluminum nitride primary sintered body is thereafter subjected to secondary sintering in a non-pressurized state to promote sintering of the aluminum nitride particles and remove a sintering-auxiliary agent, as a result of which the aluminum nitride plate is obtained. When carbon is contained in the pre-sintering compact, the carbon is removed in the secondary sintering as the sintering proceeds.

### EMBODIMENT

Hereinbelow, an embodiment of aluminum nitride particles and an aluminum nitride plate manufactured by using the aluminum nitride particles will be described. Manufacturing methods of the aluminum nitride particles and the aluminum nitride plate described below are merely for the purpose of explaining the disclosure herein, and do not limit the disclosure herein.

(Manufacture of Aluminum Nitride Particles)

Firstly, 30 grams of spherical aluminum nitride particles (Tokuyama Corporation, F grade, median diameter 1 μm) were filled in a boron nitride crucible, the crucible was placed inside a heating furnace and sintered under a nitriding atmosphere at 1700 to 2000° C. for 10 to 15 hours, and Samples 1 to 13 with different carbon concentrations and oxygen concentrations were prepared. As a result of measurement of a carbon content and an oxygen content (a oxygen concentration in an entire particle) of each spherical aluminum nitride particle (not sintered, Samples 14 and 15), the carbon concentration was 230 ppm and the oxygen concentration was 7800 ppm. Further, as a result of SEM observation of each spherical aluminum nitride particle, a perimeter ratio thereof (a particle perimeter with respect to a particle size in a plan view) was 3.1 to 3.5. Details of methods for measuring the carbon content, the oxygen content, and the perimeter ratio will be described later.

Next, the sintered aluminum nitride particles were pulverized using a dry jet mill (Aishin Technologies Co., Ltd., Nano Jetmaizer MJ-50) with a jet airflow of 1.0 m³/min. The jet airflow was changed for Samples 9, 10, and 13, and the particle size was thereby changed.

The carbon content, the oxygen content, the perimeter ratio, and the particle size were measured for pulverized Samples 1 to 13 and non-sintered Samples 14 and 15. The carbon content was measured by a pressurized sulfuric acid decomposition method described in JIS R1649 using an Inductively Coupled Plasma (ICP) optical emission spectrometer (Hitachi High-Tech Science Corporation, PS3520UV-DD). The oxygen content (in the particle surface layer and particle interior) was measured by an inert gas fusion and infrared absorption method described in JIS R1675 using an oxygen analyzer (Horiba Ltd., EMGA-6500). Specifically, in the “inert gas fusion and infrared absorption method” using the oxygen analyzer, the oxygen content detected under 1900° C. was regarded as the oxygen content of the particle surface layer, the oxygen content detected at 1900° C. or higher was regarded as the oxygen content of the particle interior, and a total of the oxygen contents of the particle surface layer and the particle interior was regarded as the particle oxygen concentration in the entire particle (in the particle).

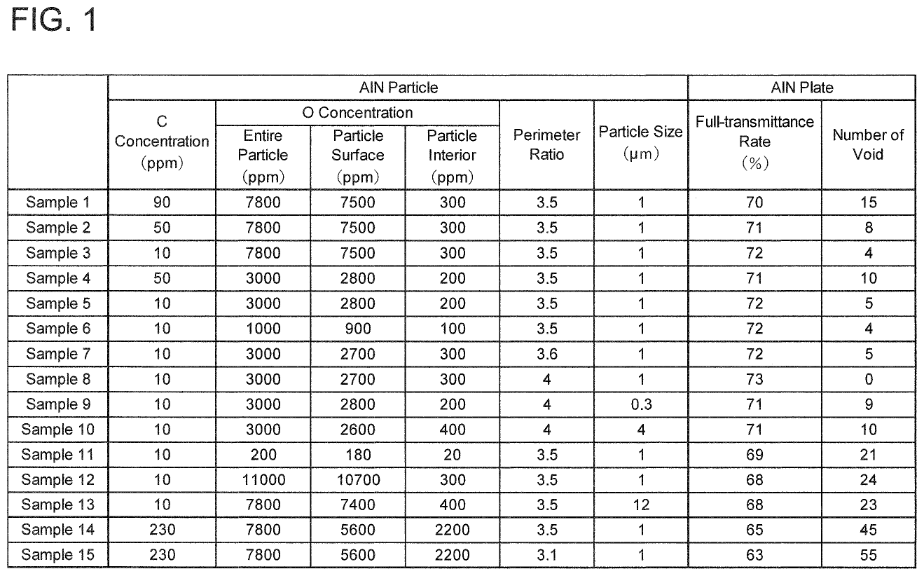

The perimeter ratio was obtained by capturing images of the obtained samples using a SEM (JEOL Ltd., JSM-6390) at 1000 to 2000 times magnification, randomly selecting ten particles from the captured images, measuring the particle size and perimeter of each of the selected particles, and dividing the perimeter by the particle size (“perimeter”/“particle size in image”). The actual particle size (median diameter) of each sample was measured using a laser scattering particle size distribution analyzer (Horiba Ltd., LA-920). Measurement results of the respective samples are shown in FIG. 1.

(Manufacture of Aluminum Nitride Plate)

Aluminum nitride plates were manufactured using the aluminum nitride particles of Samples 1 to 15. Firstly, a method of composing an auxiliary agent used for sintering the aluminum nitride plates (Ca-Al-O-based sintering auxiliary agent) will be described. The auxiliary agent is mixed in the aluminum nitride particles and sintered together with the aluminum nitride particles.

(Composing Auxiliary Agent)

47 grams of calcium carbonate (Shiraishi Calcium Kaisha, Ltd., Shilver-W), 24 grams of γ-alumina (Taimei Chemicals Co., Ltd., TM-300D), 1000 grams of alumina balls (φ15 mm), and 125 ml of IPA (Tokuyama Corporation, Tokuso IPA) were pulverized and mixed for 120 minutes at 110 rpm, and the mixture was thereby obtained. The obtained mixture was dried using a rotary evaporator. After this, the alumina balls were removed from the mixture, and 70 grams of the mixture was filled in an alumina crucible. After this, the crucible with the mixture therein is placed in the heating furnace, which was then heated to 1250° C. in atmosphere at a heating speed of 200° C./hr and maintained at 1250° C. for 3 hours. After heating, the mixture (auxiliary agent) was cooled naturally and taken out from the crucible.

(Preparation of Synthesis Material)

Next, a process of preparing a material using the aforementioned auxiliary agent will be described. The auxiliary agent (Ca-Al-O-based auxiliary agent) was added by 4.8 weight parts to the aluminum nitride particles of Samples 1 to 12, and the mixtures were each weighted to be 20 grams in total. Each of the mixtures was mixed with 300 grams of alumina balls (φ15 mm) and 60 ml of IPA (Tokuyama Corporation, Tokuso IPA) for 240 minutes at 30 rpm. The alumina balls were removed from the mixtures, which were then dried using the rotary evaporator, and synthesis materials were thereby obtained.

(Fabrication of Pre-Sintering Compact)

A material slurry was prepared by adding and mixing 7.8 weight parts of polyvinyl butyral (Sekisui Chemical Co., Ltd, Product No. BM-2) as a binder, 3.9 weight parts of di(2-ethylhexyl)phthalate (Kurogane Kasei Co., Ltd.) as a plasticizing agent, 2 weight parts of sorbitan trioleate (Kao Corporation, Rheodol SP-O30) as a dispersing agent, and 2-ethylhexanol as a dispersing medium to 100 weight parts of the synthesis material as aforementioned. An added amount of the dispersing medium was adjusted to achieve a slurry viscosity of 20000 cP. The obtained material slurry was applied on a PET film by a doctor blade method. A slurry thickness was adjusted to obtain a post-drying thickness of 30 μm. A sheet-shaped tape compact was obtained by the foregoing processes. The obtained tape compact was cut into circular shapes each having a diameter of 20 mm and 120 sheets of such circular tape compacts were stacked to obtain a pre-sintering compact. The obtained pre-sintering compact was placed on an aluminum plate with a thickness of 10 mm, placed in a vacuum package and inside thereof was vacuumed. After this, the vacuumed package was subjected to isostatic pressing in warm water of 85° C. at 100 kgf/cm², and a circular plate-shaped pre-sintering compact (sintering stack body) was thereby obtained.

(Primary Sintering)

Next, the pre-sintering compacts were placed in a degreasing furnace, and degreasing was performed at 600 ° C. for 10 hours. After this, they were sintered under the condition of 1900° C. for 10 hours with a planar pressure of 200 kgf/cm² and then cooled to a room temperature, and aluminum nitride primary sintered bodies were thereby obtained. A direction in which pressure was applied in hot pressing was a stacking direction of the pre-sintering compacts (direction substantially vertical to a surface of the tape compact). Further, the pressure application was maintained until the temperature dropped to the room temperature. The aluminum nitride particles that constituted the pre-sintering compacts grew by the primary sintering, by which voids in the compacts were eliminated. Due to this, aluminum nitride primary sintered bodies with high density (relative density) were obtained. After this, surfaces of the aluminum nitride primary sintered bodies were each polished to obtain φ20 mm and thickness of 1.5 mm.

(Secondary Sintering)

The aluminum nitride primary sintered bodies of which thicknesses were adjusted were placed on aluminum nitride plates and sintered at the sintering temperature of 1900° C. for 75 hours with the heating furnace in the nitrogen atmosphere, and aluminum nitride sintered bodies (aluminum nitride plates) were obtained. The auxiliary agent (auxiliary agent used in the sintering) that remained in the aluminum nitride primary sintered bodies was eliminated by the second sintering, and transparent aluminum nitride sintered bodies were obtained.

(Evaluation of Aluminum Nitride Plates)

The full-transmittance rate and the number of voids in each of the obtained aluminum nitride plates were measured. Results thereof are shown in FIG. 1. The full-transmittance rate and the number of voids in the plates were measured by the following methods.

(Full-Transmittance Rate)

Each aluminum nitride plate was cut into a size of 10 mm×10 mm. Four aluminum nitride plates obtained therefrom were fixed and spaced evenly on a perimeter portion of an alumina surface plate (φ68 mm) (such that an angle formed between the center of the surface plate and the adjacent aluminum nitride sintered bodies is 90°), polished by a copper lapping disk on which a slurry containing diamond abrasives with a particle size of 9 μm and 3 μm was dripped, and further polished for 300 minutes with a buffer disk on which a slurry containing colloidal silica was dripped. After this, the polished samples with the size 10 mm×10 mm×0.4 mm thickness were washed for 3 minutes in each of ion exchange water, acetone, and ethanol in this order, and their full line transmittance rates at a wavelength of 450 nm were measured using a spectrophotometer (PerkinElmer Inc., Lambda900).

(Number of Voids in Aluminum Nitride Plates)

A cross-section of a center portion of each aluminum nitride plate in a thickness direction was observed using the SEM (JEOL Ltd., JSM-6390) at 3000 times magnification, and the number of voids in a visible field was counted. The number of voids were observed randomly for fifty visible fields, and the number of voids per 1 mm² was calculated therefrom.

As shown in FIG. 1, the carbon content (C concentration) in each of the spherical aluminum nitride particles (Samples 14, 15) was 230 ppm. Contrary to this, all the samples obtained by sintering the spherical aluminum nitride particles under the nitriding atmosphere

(Samples 1 to 13) had the carbon content (C concentration) of 100 ppm or less in each of the spherical aluminum nitride particles. This result indicates that the residual carbon contained in market-available aluminum nitride particles (spherical aluminum nitride particles) was removed.

It has been confirmed that each of the aluminum nitride plates (Samples 1 to 13) fabricated using the aluminum nitride particle of which carbon content is 100 ppm or less has the fewer number of voids in the aluminum nitride plate and has a higher full-transmittance rate as compared to the aluminum nitride plates (Samples 14, 15) fabricated using the spherical aluminum nitride particles. Specifically, all of the aluminum nitride plates fabricated using Samples 1 to 13 exhibited the full-transmittance rates of 68% or higher, indicating that they have excellent optical transparency. It has been confirmed that the full-transmittance rate increases as the carbon contents in the aluminum nitride particles decreases (Samples 1 to 3, Samples 4 and 5). Further, it has been confirmed that the number of voids in the aluminum nitride plate decreases as the carbon contents in the aluminum nitride particles decreases.

It has been confirmed that the full-transmittance rate of the aluminum nitride plate tends to increase as the number of voids in the aluminum nitride plate decreases. That is, it has been confirmed that by decreasing the number of voids in the aluminum nitride plate, scattering of the light (ultraviolet light of 450 nm) in the aluminum nitride plate is suppressed and the full-transmittance rate of the aluminum nitride plate can thereby be increased.

Samples 1 to 13 all exhibited excellent full-transmittance rate (68% or higher), however, the sample with the oxygen content (total O concentration in the sample) less than 500 ppm (Sample 11) and the sample with the oxygen content exceeding 8000 ppm (Sample 12) resulted in the larger number of voids in the aluminum nitride plates and the slightly lower full-transmittance rates as compared to those with the oxygen content of 500 ppm or more and 8000 ppm or less (more accurately, 1000 ppm or more and 7800 ppm or less) (Samples 3, 5, 6, 11, and 12). This result indicates that the liquid phase that occurs in the course of manufacturing the aluminum nitride plate (primary sintering) can be in a suitable range by adjusting the oxygen contents in the aluminum nitride particles in a suitable range (500 ppm or more and 8000 ppm or less), by which the void generation in the aluminum nitride plate can be decreased. It has been confirmed that in the range of the oxygen content being 500 to 8000 ppm, the oxygen content does not significantly affect the result of the full-transmittance rate (Samples 2 and 4, Samples 3, 5, and 6). Further, it has been confirmed that all of Samples 1 to 13 each have the O concentration in the particle interior at 500 ppm or less (more accurately, 400 ppm or less).

Each of the aluminum nitride particles in Samples 1 to 10 has the perimeter ratio of 3.5 or more and 4 or less and obtains excellent full-transmittance rate, and it has been confirmed that the full-transmittance rate tends to increase as the perimeter ratio increases (Samples 5, 7, and 8). Further, from the results of Samples 14 and 15 as well, it has been confirmed that the full- transmittance rate tends to increase as the perimeter ratio increases.

In comparing Samples 3 and 13, both achieved excellent full-transmittance rate, however, Sample 13 resulted in the larger number of voids in the aluminum nitride plate and a slightly lower full-transmittance rate as compared to Sample 3. It is inferred that large voids (gaps between the aluminum nitride particles) in Sample 13 were generated in the compact upon fabricating the pre-sintering compact and small portions of these voids remained even after the sintering. Although both achieved excellent full-transmittance rates, the samples that used the aluminum nitride particles each having the particle diameter of 1 μm exhibited the best full-transmittance rate

(Samples 8 to 10).

Specific examples of the present disclosure have been described in detail, however, these are mere exemplary indications and thus do not limit the scope of the claims. The art described in the claims include modifications and variations of the specific examples presented above. Technical features described in the specification and the drawings may technically be useful alone or in various combinations, and are not limited to the combinations as originally claimed. Further, the art described in the specification and the drawings may concurrently achieve a plurality of aims, and technical significance thereof resides in achieving any one of such aims.

1. An aluminum nitride particle used as a material for an aluminum nitride plate, wherein
a carbon content in the aluminum nitride particle as measured using a pressurized sulfuric acid decomposition method is 100 ppm or less.

2. The aluminum nitride particle according to claim 1, wherein
an oxygen content in the aluminum nitride particle is 500 ppm or more and 8000 ppm or less.

3. The aluminum nitride particle according to claim 2, wherein
a first region in which the oxygen content is high is provided on a surface layer of the aluminum nitride particle,
a second region in which the oxygen content is lower than the first region is provided inward of the first region, and
the oxygen content in the second region is 500 ppm.

4. The aluminum nitride particle according to claim 1, wherein
when the aluminum nitride particle is viewed in a plan view, a perimeter of the particle with respect to a size of the particle in the plane view is 3.5 times or more and 7 times or less the size.

5. The aluminum nitride particle according to claim 1, wherein
a size of the aluminum nitride particle is 0.1 μm or more and 10 μm or less.
